(19) United States
(12) Patent Application Publication
(10) Pub. No.: US 2016/0207290 A1
(43) Pub. Date: Jul. 21, 2016

(54) THIN GLASS LAMINATE STRUCTURES

(71) Applicant: CORNING INCORPORATED, Corning, NY (US)

(72) Inventors: Thomas Michael Cleary, Elmira, NY (US); Kintu Odinga X Early, Painted Post, NY (US); Mark Stephen Friske, Campbell, NY (US); Shandon Dee Hart, Corning, NY (US); Guangli Hu, Berkeley Heights, NJ (US); Brenna Elizabeth Marcellus, Corning, NY (US); Chunhe Zhang, Horseheads, NY (US)

(73) Assignee: Corning Incorporated, Corning, NY (US)

(21) Appl. No.: 14/915,437

(22) PCT Filed: Aug. 28, 2014
(86) PCT No.: PCT/US14/53122

§ 371 Date: Feb. 29, 2016

Related U.S. Application Data
(60) Provisional application No. 61/871,602, filed on Aug. 29, 2013.

(51) Int. Cl. B32B 17/10; B32B 37/18

(52) U.S. Cl. CPC B32B 17/10036; B32B 17/10091; B32B 17/10137; B32B 17/10146; B32B 17/10366; B32B 37/182; B32B 2605/006; B32B 2398/00; B32B 2315/08; B32B 2307/412; B32B 2307/558

(57) ABSTRACT

A laminate structure having a first glass layer, a second glass layer, and at least one polymer interlayer intermediate the first and second glass layers. In some embodiments, the first glass layer can be comprised of a strengthened glass having first and second surfaces, the second surface being adjacent the interlayer and chemically polished and the second glass layer can be comprised of a strengthened glass having third and fourth surfaces, the fourth surface being opposite the interlayer and chemically polished and the third surface being adjacent the interlayer and having a substantially transparent coating formed thereon. In another embodiment, the first glass layer is curved and the second glass layer is substantially planar and cold formed onto the first glass layer to provide a difference in surface compressive stresses on the surfaces of the second glass layer.

This application claims the benefit of priority to U.S. Application No. 61/871,602 filed on Aug. 29, 2013 the content of which is incorporated herein by reference in its entirety.

### BACKGROUND

Glass laminates can be used as windows and glazing in architectural and vehicle or transportation applications, including automobiles, rolling stock, locomotive and airplanes. Glass laminates can also be used as glass panels in balustrades and stairs, and as decorative panels or coverings for walls, columns, elevator cabs, kitchen appliances and other applications. As used herein, a glazing or a laminated glass structure can be a transparent, semi-transparent, translucent or opaque part of a window, panel, wall, enclosure, sign or other structure. Common types of glazing that are used in architectural and/or vehicular applications include clear and tinted laminated glass structures.

Conventional automotive glazing constructions include two plies of 2 mm soda lime glass with a polyvinyl butyral (PVB) interlayer. These laminate constructions have certain advantages, including low cost and a sufficient impact resistance for automotive and other applications. However, because of their limited impact resistance and higher weight, these laminates exhibit poor performance characteristics, including a higher probability of breakage when struck by roadside debris, vandals and other objects of impact as well as well as lower fuel efficiencies for a respective vehicle.

In applications where strength is important (such as the above automotive application), the strength of conventional glass can be enhanced by several methods, including coatings, thermal tempering, and chemical strengthening (ion exchange). Thermal tempering is conventionally employed in such applications with thick, monolithic glass sheets, and has the advantage of creating a thick compressive layer through the glass surface, typically 20 to 25% of the overall glass thickness. The magnitude of the compressive stress is relatively low, however, typically less than 100 MPa. Furthermore, thermal tempering becomes increasingly ineffective for relatively thin glass, e.g., less than about 2 mm.

In contrast, ion exchange (IX) techniques can produce high levels of compressive stress in the treated glass, as high as about 1000 MPa at the surface, and is suitable for very thin glass. Ion exchange techniques, however, can be limited to relatively shallow compressive layers, typically on the order of tens of micrometers. This high compressive stress can result in very high blunt impact resistance, which might not pass particular safety standards for automotive applications, such as the ECE (UN Economic Commission for Europe) R43 Head Form Impact Test, where glass is required to break at a certain impact load to prevent injury. Conventional research and development efforts have been focused on controlled or preferential breakage of vehicular laminates at the expense of the impact resistance thereof.

For certain automobile glazings or laminates, e.g., windshields and the like, the materials employed therein must pass a number of safety criteria, such as the ECE R43 Head Form Impact Test. If a product does not break under the defined conditions of the test, the product would not be acceptable for safety reasons. This is one reason why windshields are conventionally made of laminated annealed glass rather than tempered glass.

Tempered glass (both thermally tempered and chemically tempered) has the advantage of being more resistant to breakage which can be desirable to enhance the reliability of laminated automobile glazing. In particular, thin, chemically-tempered glass can be desirable for use in making strong, lighter-weight auto glazing. Conventional laminated glass made with such tempered glass, however, does not meet the head-impact safety requirements. One method of forming a thin, chemically-tempered glass compliant with head-impact safety requirements can be to perform a thermal annealing process after the glass is chemically-tempered. This has the effect of reducing compressive stress of the glass thereby reducing the stress required to cause the glass to break. Other methods of forming a thin, chemically tempered glass compliant with head-impact safety requirements can be to perform localized annealing of the glass structure(s) using laser technology, induction and microwave sources or using masking during the ion exchange process. These methods are described in co-pending U.S. Application No. 61/869,962 filed Aug. 26, 2013, the entirety of which is incorporated herein by reference.

Additionally, in automotive laminates controlled breakage under impact is preferred to lessen the extent of lacerations and impact injuries to passengers. Ideally, such laminates should also be made to maximize impact resistance from external impacting objects such as stones, hail, objects dropped from overpasses, impacts from would-be thieves, etc., and also possess a controlled fracture behavior from internal impacting objects to meet head form criteria.

### SUMMARY

The embodiments disclosed herein generally relate to glass structures, automobile glazings or laminates having laminated, tempered glass.

Some embodiments provide a laminated structure having a first glass layer, a second glass layer, and a polymer interlayer therebetween. One or more of the glass layers can include a sheet of thin, high strength glass having an improved impact behavior. Other embodiments provide a laminated structure having at least one of the glass layers as mechanically pre-stressed to achieve desired breakage behavior.

Additional embodiments provide a laminate structure having a first glass layer, a second glass layer, and at least one polymer interlayer intermediate the first and second glass layers. The first glass layer can be comprised of a strengthened glass having first and second surfaces, the second surface being adjacent the interlayer and chemically polished, and the second glass layer can be comprised of a strengthened glass having third and fourth surfaces, the fourth surface being opposite the interlayer and chemically polished and the third surface being adjacent the interlayer and having a substantially transparent, optionally low-haze, and optionally low-birefringence coating formed thereon. The laminate may optionally comprise a second substantially transparent coating on the first surface of the first glass layer (the outermost glass surface).

Some embodiments of the present disclosure provide a method of providing a laminate structure. The method includes providing a first glass layer and a second glass layer, strengthening one or both of the first and second glass layers and laminating the first and second glass layers using at least one polymer interlayer intermediate the first and second glass layers. The method also includes chemically polishing a second surface of the first glass layer, the second surface being adjacent the interlayer, chemically polishing a fourth surface of the second glass layer, the fourth surface being opposite the interlayer, and forming a substantially transparent coating, either global or localized, on a third surface of the second glass layer, the third surface being adjacent the interlayer.

Further embodiments of the present disclosure provide a laminate structure having a curved first glass layer, a substantially planar second glass layer, and at least one polymer interlayer intermediate the first and second glass layers. The first glass layer can be comprised of an annealed glass, and the second glass layer can be comprised of a strengthened glass having a surface adjacent the interlayer and a surface opposite the interlayer, the second glass layer being cold formed to the curvature of the first glass layer to provide a difference in surface compressive stresses on the two surfaces.

Additional embodiments provide a method of cold forming a glass structure comprising the steps of providing a curved first glass layer, a substantially planar second glass layer, and at least one polymer interlayer intermediate the first and second glass layers and laminating the first glass layer, second glass layer and polymer interlayer together at a temperature less than the softening temperature of the first and second glass layers. The first glass layer can be comprised of an annealed glass and the second glass layer is comprised of a strengthened glass having a first surface adjacent the interlayer and a second surface opposite the interlayer, and the second glass layer can be provided with a substantially similar curvature to that of the first glass layer as a function of said laminating to provide a difference in surface compressive stresses on the first and second surfaces.

It is to be understood that both the foregoing general description and the following detailed description present embodiments of the present disclosure, and are intended to provide an overview or framework for understanding the nature and character of the claimed subject matter. The accompanying drawings are included to provide a further understanding of the present disclosure, and are incorporated into and constitute a part of this specification. The drawings illustrate various embodiments and together with the description serve to explain the principles and operations of the claimed subject matter.

### BRIEF DESCRIPTION OF THE DRAWINGS

For the purposes of illustration, there are forms shown in the drawings that are presently preferred, it being understood, however, that the embodiments disclosed and discussed herein are not limited to the precise arrangements and instrumentalities shown.

FIG. 1 is a flow diagram illustrating some embodiments of the present disclosure.

FIG. 2 is a cross sectional illustration of some embodiments of the present disclosure.

FIG. 3 is a perspective view of additional embodiments of the present disclosure.

FIG. 4 is a Weibull plot summarizing ball drop height breakage data for three types of laminate structures upon impact on the external surface thereof.

FIGS. 5A-5B are microscopic views, 25× and 50×, respectively, of an exemplary coated surface of a thin glass laminate structure.

FIG. 5C is an atomic force microscopy (AFM) view of an exemplary coated surface of a thin glass laminate structure.

FIG. 6 is a flow diagram illustrating additional embodiments of the present disclosure.

FIG. 7 is a Weibull plot summarizing ball drop height breakage data for three exemplary laminate structures upon impact on the external surface thereof.

FIGS. 8A-8B are cross sectional stress profiles of an exemplary inner glass layer according to some embodiments of the present disclosure.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other.

Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range. As used herein, the indefinite articles “a,” and “an,” and the corresponding definite article “the” mean “at least one” or “one or more,” unless otherwise specified

The following description of the present disclosure is provided as an enabling teaching thereof and its best, currently-known embodiment. Those skilled in the art will recognize that many changes can be made to the embodiment described herein while still obtaining the beneficial results of the present disclosure. It will also be apparent that some of the desired benefits of the present disclosure can be obtained by selecting some of the features of the present disclosure without utilizing other features. Accordingly, those of ordinary skill in the art will recognize that many modifications and adaptations of the present disclosure are possible and can even be desirable in certain circumstances and are part of the present disclosure. Thus, the following description is provided as illustrative of the principles of the present disclosure and not in limitation thereof.

Those skilled in the art will appreciate that many modifications to the exemplary embodiments described herein are possible without departing from the spirit and scope of the present disclosure. Thus, the description is not intended and should not be construed to be limited to the examples given but should be granted the full breadth of protection afforded by the appended claims and equivalents thereto. In addition, it is possible to use some of the features of the present disclosure without the corresponding use of other features. Accordingly, the foregoing description of exemplary or illustrative embodiments is provided for the purpose of illustrating the principles of the present disclosure and not in limitation thereof and can include modification thereto and permutations thereof.

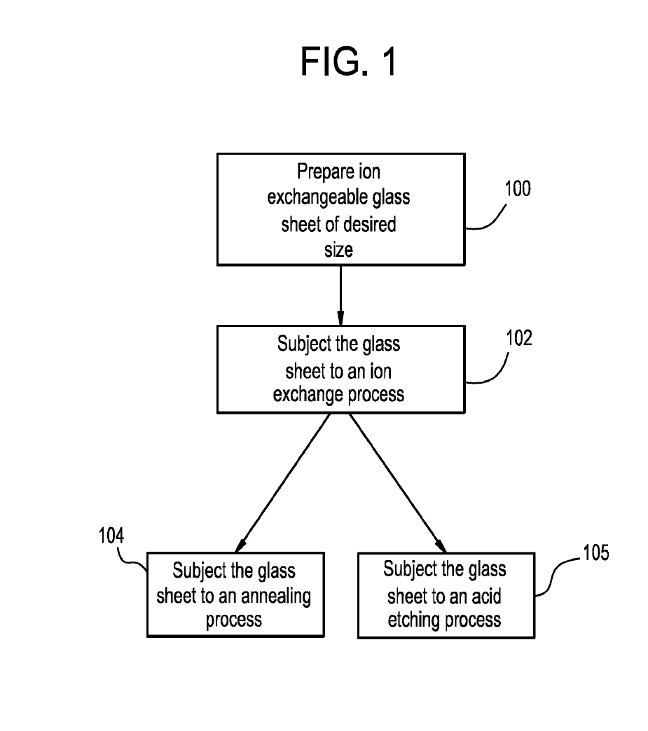

FIG. 1 is a flow diagram illustrating some embodiments of the present disclosure. With reference to FIG. 1, some embodiments include the application of one or more processes for producing a relatively thin glass sheet (on the order of about 2 mm or less) having certain characteristics, such as compressive stress (CS), relatively high depth of compressive layer (DOL), and/or moderate central tension (CT). The process includes preparing a glass sheet capable of ion exchange (step 100). The glass sheet can then be subjected to an ion exchange process (step 102), and thereafter the glass sheet can be subjected to an anneal process (step 104) for some embodiments or an acid etching process (step 105) for other embodiments or both.

The ion exchange process 102 can involve subjecting the glass sheet to a molten salt bath including KNO₃, preferably relatively pure KNO₃ for one or more first temperatures within the range of about 400-500° C. and/or for a first time period within the range of about 1-24 hours, such as, but not limited to, about 8 hours. It is noted that other salt bath compositions are possible and would be within the skill level of an artisan to consider such alternatives. Thus, the disclosure of KNO₃ should not limit the scope of the claims appended herewith. Such an exemplary ion exchange process can produce an initial compressive stress (iCS) at the surface of the glass sheet, an initial depth of compressive layer (iDOL) into the glass sheet, and an initial central tension (iCT) within the glass sheet.

In general, after an exemplary ion exchange process, the initial compressive stress (iCS) can exceed a predetermined (or desired) value, such as being at or greater than about 500 MPa, and can typically reach 600 MPa or higher, or even reach 1000 MPa or higher in some glasses and under some processing profiles. Alternatively, after an exemplary ion exchange process, initial depth of compressive layer (iDOL) can be below a predetermined (or desired) value, such as being at or less than about 75 μm or even lower in some glasses and under some processing profiles. Alternatively, after an exemplary ion exchange process, initial central tension (iCT) can exceed a predetermined (or desired) value, such as above a predetermined frangibility limit of the glass sheet, which can be at or above about 40 MPa, or more particularly at or above about 48 MPa in some glasses.

If the initial compressive stress (iCS) exceeds a desired value, initial depth of compressive layer (iDOL) is below a desired value, and/or initial central tension (iCT) exceeds a desired value, this can lead to undesirable characteristics in a final product made using the respective glass sheet. For example, if the initial compressive stress (iCS) exceeds a desired value (reaching for example, 1000 MPa), then fracture of the glass under certain circumstances might not occur. Although this may be counter-intuitive, in some circumstances the glass sheet should be able to break, such as in an automotive glass application where the glass must break at a certain impact load to prevent injury.

Further, if the initial depth of compressive layer (iDOL) is below a desired value, then under certain circumstances the glass sheet can break unexpectedly and under undesirable circumstances. Typical ion exchange processes can result in an initial depth of compressive layer (iDOL) being no more than about 40-60 μm, which can be less than the depth of scratches, pits, etc., developed in the glass sheet during use. For example, it has been discovered that installed automotive glazing (using ion exchanged glass) can develop external scratches reaching as deep as about 75 μm or more due to exposure to abrasive materials such as silica sand, flying debris, etc., within the environment in which the glass sheet is used. This depth can exceed the typical depth of compressive layer, which can lead to the glass unexpectedly fracturing during use.

Finally, if the initial central tension (iCT) exceeds a desired value, such as reaching or exceeding a chosen frangibility limit of the glass, then the glass sheet can break unexpectedly and under undesirable circumstances. For example, it has been discovered that a 4 inch×4 inch×0.7 mm sheet of Corning Gorilla® Glass exhibits performance characteristics in which undesirable fragmentation (energetic failure into a large number of small pieces when broken) occurs when a long single step ion exchange process (8 hours at 475° C.) was performed in pure KNO₃. Although a DOL of about 101 μm was achieved, a relatively high CT of 65 MPa resulted, which was higher than the chosen frangibility limit (48 MPa) of the subject glass sheet.

In the non-limiting embodiments in which an anneal is required, after the glass sheet has been subject to ion exchange, the glass sheet can be subjected to an annealing process 104 by elevating the glass sheet to one or more second temperatures for a second period of time. For example, the annealing process 104 can be carried out in an air environment, can be performed at second temperatures within the range of about 400-500° C., and can be performed in a second time period within the range of about 4-24 hours, such as, but not limited to, about 8 hours. The annealing process 104 can thus cause at least one of the initial compressive stress (iCS), the initial depth of compressive layer (iDOL), and the initial central tension (iCT) to be modified.

For example, after the annealing process 104, the initial compressive stress (iCS) can be reduced to a final compressive stress (fCS) which is at or below a predetermined value. By way of example, the initial compressive stress (iCS) can be at or greater than about 500 MPa, but the final compressive stress (fCS) can be at or less than about 400 MPa, 350 MPa, or 300 MPa. It is noted that the target for the final compressive stress (fCS) can be a function of glass thickness as in thicker glass a lower fCS can be desirable, and in thinner glass a higher fCS can be tolerable.

Additionally, after the annealing process 104, the initial depth of compressive layer (iDOL) can be increased to a final depth of compressive layer (fDOL) at or above the predetermined value. By way of example, the initial depth of compressive layer (iDOL) can be at or less than about 75 μm, and the final depth of compressive layer (fDOL) can be at or above about 80 μm or 90 μm, such as 100 μm or more.

Alternatively, after the annealing process 104, the initial central tension (iCT) can be reduced to a final central tension (fCT) at or below the predetermined value. By way of example, the initial central tension (iCT) can be at or above a chosen frangibility limit of the glass sheet (such as between about 40-48 MPa), and the final central tension (fCT) can be below the chosen frangibility limit of the glass sheet. Additional examples for generating exemplary ion exchangeable glass structures are described in co-pending U.S. application Ser. No. 13/626,958, filed Sep. 26, 2012 and U.S. application Ser. No. 13/926,461, filed Jun. 25, 2013 the entirety of each being incorporated herein by reference.

As noted above the conditions of the ion exchange step and the annealing step can be adjusted to achieve a desired compressive stress at the glass surface (CS), depth of compressive layer (DOL), and central tension (CT). The ion exchange step can be carried out by immersion of the glass sheet into a molten salt bath for a predetermined period of time, where ions within the glass sheet at or near the surface thereof are exchanged for larger metal ions, for example, from the salt bath. By way of example, the molten salt bath can include KNO₃, the temperature of the molten salt bath can be within the range of about 400-500° C., and the predetermined time period can be within the range of about 1-24 hours, and preferably between about 2-8 hours. The incorporation of the larger ions into the glass strengthens the sheet by creating a compressive stress in a near surface region. A corresponding tensile stress can be induced within a central region of the glass sheet to balance the compressive stress.

By way of further example, sodium ions within the glass sheet can be replaced by potassium ions from the molten salt bath, though other alkali metal ions having a larger atomic radius, such as rubidium or cesium, can also replace smaller alkali metal ions in the glass. According to some embodiments, smaller alkali metal ions in the glass sheet can be replaced by Ag+ ions. Similarly, other alkali metal salts such as, but not limited to, sulfates, halides, and the like can be used in the ion exchange process.

The replacement of smaller ions by larger ions at a temperature below that at which the glass network can relax produces a distribution of ions across the surface of the glass sheet resulting in a stress profile. The larger volume of the incoming ion produces a compressive stress (CS) on the surface and tension (central tension, or CT) in the center region of the glass. The compressive stress is related to the central tension by the following approximate relationship:

$$CS = CT ( \frac{t - 2 DOL}{DOL} )$$

where t represents the total thickness of the glass sheet and DOL represents the depth of exchange, also referred to as depth of compressive layer.

Any number of specific glass compositions can be employed in producing the glass sheet. For example, ion-exchangeable glasses suitable for use in the embodiments herein include alkali aluminosilicate glasses or alkali aluminoborosilicate glasses, though other glass compositions are contemplated. As used herein, “ion exchangeable” means that a glass is capable of exchanging cations located at or near the surface of the glass with cations of the same valence that are either larger or smaller in size.

For example, a suitable glass composition comprises SiO₂, B₂O₃ and Na₂O, where (SiO₂+B₂O₃)≧66 mol. %, and Na₂O≧9 mol. %. In an embodiment, the glass sheets include at least 4 wt. % aluminum oxide or 4 wt. % zirconium oxide. In a further embodiment, a glass sheet includes one or more alkaline earth oxides, such that a content of alkaline earth oxides is at least 5 wt. %. Suitable glass compositions, in some embodiments, further comprise at least one of K₂O, MgO, and CaO. In a particular embodiment, the glass can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition suitable for forming hybrid glass laminates comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≦(Li₂O+Na₂O+K₂O)≦20 mol. % and 0 mol. %≦(MgO+CaO)≦10 mol. %.

A still further example glass composition comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≦(Li₂O+Na₂O+K₂O)≦18 mol. % and 2 mol. %≦(MgO+CaO)≦7 mol. %.

In another embodiment, an alkali aluminosilicate glass comprises, consists essentially of, or consists of: 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

In a particular embodiment, an alkali aluminosilicate glass comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio

$$\frac{{Al}_{2} {O}_{3} + {B}_{2} {O}_{3}}{Σ modifiers} > 1 ,$$

where in the ratio the components are expressed in mol. % and the modifiers are alkali metal oxides. This glass, in particular embodiments, comprises, consists essentially of, or consists of: 58-72 mol. % SiO₂; 9-17 mol. % Al₂O₃; 2-12 mol. % B₂O₃; 8-16 mol. % Na₂O; and 0-4 mol. % K₂O, wherein the ratio

$$\frac{{Al}_{2} {O}_{3} + {B}_{2} {O}_{3}}{Σ modifiers} > 1.$$

In yet another embodiment, an alkali aluminosilicate glass substrate comprises, consists essentially of, or consists of: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; wherein 12 mol.≦% Li₂O+Na₂O+K₂O≦20 mol. % and 0 mol. %≦MgO+CaO≦10 mol. %.

In still another embodiment, an alkali aluminosilicate glass comprises, consists essentially of, or consists of: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≦SiO₂+B₂O₃+CaO≦69 mol. %; Na₂O+K₂O+B₂O₃+MgO+CaO+SrO>10 mol. %; 5 mol. %≦MgO+CaO+SrO≦8 mol. %; (Na₂O+B₂O₃)≦Al₂O₃≦2 mol. %; 2 mol. %≦Na₂O≦Al₂O₃≦6 mol. %; and 4 mol. %≦(Na₂O+K₂O)≦Al₂O₃≦10 mol. %. Additional compositions of exemplary glass structures are described in co-pending U.S. application Ser. No. 13/626,958, filed Sep. 26, 2012 and U.S. application Ser. No. 13/926,461, filed Jun. 25, 2013 the entirety of each being incorporated herein by reference.

The processes described herein can be suitable for a range of applications. One application of particular interest can be, but is not limited to, automotive glazing applications, whereby the process enables production of glass which can pass automotive impact safety standards. Other applications can be identified by those knowledgeable in the art.

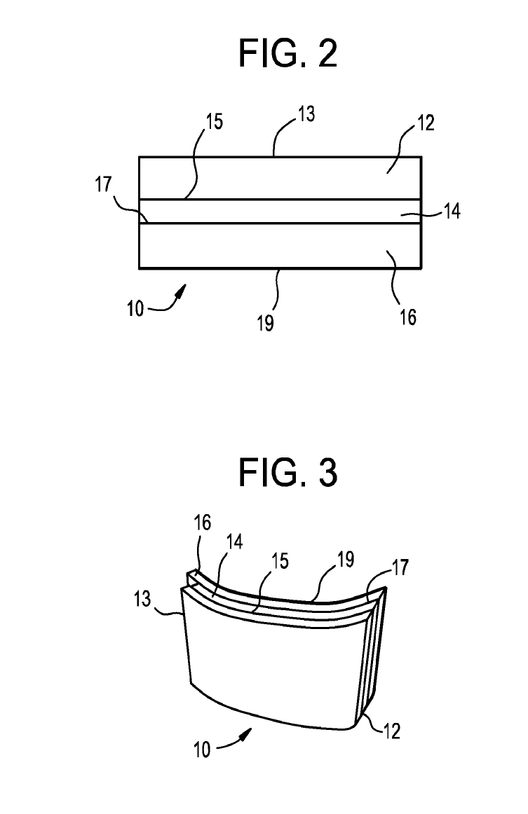

FIG. 2 is a cross sectional illustration of some embodiments of the present disclosure. FIG. 3 is a perspective view of additional embodiments of the present disclosure. With reference to FIGS. 2 and 3, an exemplary embodiment can include two layers of chemically strengthened glass, e.g., Gorilla® Glass, that have been heat treated, ion exchanged, as described above. Exemplary embodiments can possess a surface compression or compressive stress of approximately 700 MPa and a DOL of greater than about 40 microns. In a preferred embodiment, a laminate 10 can be comprised of an outer layer 12 of glass having a thickness of less than or equal to about 1.0 mm and having a residual surface CS level of between about 500 MPa to about 950 MPa with a DOL of greater than 35 microns. In one embodiment, an interlayer 14 can have a thickness of approximately 0.8 mm. Exemplary interlayers 14 can include, but are not limited to poly-vinyl-butyral or other suitable polymeric materials. In additional embodiments, any of the surfaces of the outer and/or inner layers 12, 16 can be acid etched to improve durability to external impact events. For example, in one embodiment, a first surface 13 of the outer layer 12 is acid etched and/or another surface 17 of the inner layer is acid etched. In another embodiment, a first surface 15 of the outer layer is acid etched and/or another surface 19 of the inner layer is acid etched. Acid etching of these surfaces can reduce the number, size and severity of flaws (not shown) in the respective surface of the outer and/or inner glass sheet 12, 16. Surface flaws act as fracture sites in the glass sheets. Reducing the number, the size and severity of the flaws in these surfaces can remove and minimize the size of potential fracture initiation sites in these surfaces to thereby strengthen the surface of the respective glass sheets.

The use of an acid etch surface treatment can comprise contacting one surface of a glass sheet with an acidic glass etching medium and can be versatile, readily tailored to most glasses, and readily applied to both planar and complex cover glass sheet geometries. Further, exemplary acid etching has been found to be effective to reduce strength variability, even in glass having a low incidence of surface flaws, including up-drawn or down-drawn (e.g., fusion-drawn) glass sheet that are conventionally thought to be largely free of surface flaws introduced during manufacture or during post-manufacturing processing. An exemplary acid treatment step can provide a chemical polishing of a glass surface that can alter the size, alter the geometry of surface flaws, and/or reduce the size and number of surface flaws but have a minimal effect on the general topography of the treated surface. In general, acid etching treatments can be employed to remove not more than about 4 μm of surface glass, or in some embodiments not more than 2 μm of surface glass, or not more than 1 μm of surface glass. The acid etch treatment can be advantageously performed prior to lamination to protect the respective surface from the creation of any new flaws.

Acid removal of more than a predetermined thickness of surface glass from chemically tempered glass sheet should be avoided to ensure that the thickness of the surface compression layer and the level of surface compressive stress provided by that layer are not unacceptably reduced as this could be detrimental to the impact and flexural damage resistance of a respective glass sheet. Additionally, excessive etching of the glass surface can increase the level of surface haze in the glass to objectionable levels. For window, automotive glazing, and consumer electronics display applications, typically no or very limited visually detectable surface haze in the glass cover sheet for the display is permitted.

A variety of etchant chemicals, concentrations, and treatment times can be used to achieve a desirable level of surface treatment and strengthening in embodiments of the present disclosure. Exemplary chemicals useful for carrying out the acid treatment step include fluoride-containing aqueous treating media containing at least one active glass etching compound including, but not limited to, HF, combinations of HF with one or more of HCL, HNO₃ and H₂SO₄, ammonium bifluoride, sodium bifluoride and other suitable compounds. For example, an aqueous acidic solution having 5 vol. % HF (48%) and 5 vol. % H₂SO₄ (98%) in water can improve the ball drop performance of ion-exchange-strengthened alkali aluminosilicate glass sheet having a thickness in the range of about 0.5 mm to about 1.5 mm using treatment times as short as one minute in duration. It should be noted that exemplary glass layers not subjected to ion-exchange strengthening or thermal tempering, whether before or after acid etching, can require different combinations of etching media to achieve large improvements in ball drop test results.

Maintaining adequate control over the thickness of the glass layer removed by etching in HF-containing solutions can be facilitated if the concentrations of HF and dissolved glass constituents in the solutions are closely controlled. While periodic replacement of the entire etching bath to restore acceptable etching rates is effective for this purpose, bath replacement can be expensive and the cost of effectively treating and disposing of depleted etching solutions can be high. Exemplary methods for etching glass layers is described in co-pending International Application No. PCT/US13/43561, filed May 31, 2013, the entirety of which is incorporated herein by reference.

Satisfactorily strengthened glass sheets or layers can retain a compressive surface layer having a DOL of at least 30 μm or even 40 μm, after surface etching, with the surface layer providing a peak compressive stress level of at least 500 MPa, or even 650 MPa. To provide thin alkali aluminosilicate glass sheets offering this combination of properties, sheet surface etching treatments of limited duration can be required. In particular, the step of contacting a surface of the glass sheet with an etching medium can be carried out for a period of time not exceeding that required for effective removal of 2 μm of surface glass, or in some embodiments not exceeding that required for effective removal of 1 μm of surface glass. Of course, the actual etching time required to limit glass removal in any particular case can depend upon the composition and temperature of the etching medium as well as the composition of the solution and the glass being treated; however, treatments effective to remove not more than about 1 μm or about 2 μm of glass from the surface of a selected glass sheet can be determined by routine experiment.

An alternative method for ensuring that glass sheet strengths and surface compression layer depths are adequate can involve tracking reductions in surface compressive stress level as etching proceeds. Etching time can then be controlled to limit reductions in surface compressive stress necessarily caused by the etching treatment. Thus, in some embodiments the step of contacting a surface of a strengthened alkali aluminosilicate glass sheet with an etching medium can be carried out for a time not exceeding a time effective to reduce the compressive stress level in the glass sheet surface by 3% or another acceptable amount. Again, the period of time suitable for achieving a predetermined amount of glass removal can depend upon the composition and temperature of the etching medium as well as the composition of the glass sheet, but can also readily be determined by routine experiment. Additional details regarding glass surface acid or etching treatments can be found in co-pending U.S. patent application Ser. No. 12/986,424 filed Jan. 7, 2011, the entirety of which is hereby incorporated by reference.

Additional etching treatments can be localized in nature. For example, surface decorations or masks can be placed on a portion(s) of the glass sheet or article. The glass sheet can then be etched to increase surface compressive stress in the area exposed to the etching but the original surface compressive stress (e.g., the surface compressive stress of the original ion exchanged glass) can be maintained in the portion(s) underlying the surface decoration or mask. Of course, the conditions of each process step can be adjusted based on the desired compressive stress at the glass surface(s), desired depth of compressive layer, and desired central tension.

In another embodiment of the present disclosure, at least one layer of thin but high strength glass can be used to construct an exemplary laminate structure. In such an embodiment, chemically strengthened glass, e.g., Gorilla® Glass can be used for the outer layer 12 and/or inner layer 16 of glass for an exemplary laminate 10. In another embodiment, the inner layer 16 or outer layer 12 of glass can be conventional soda lime glass, annealed glass, or the like. Exemplary thicknesses of the outer and/or inner layers 12, 16 can range in thicknesses from 0.55 mm to 1.5 mm to 2.0 mm or more. Additionally, the thicknesses of the outer and inner layers 12, 16 can be different in a laminate structure 10. Exemplary glass layers can be made by fusion drawing, as described in U.S. Pat. Nos. 7,666,511, 4,483,700 and 5,674,790, the entirety of each being incorporated herein by reference, and then chemically strengthening such drawn glass. Exemplary glass layers 12, 16 can thus possess a deep DOL of CS and can present a high flexural strength, scratch resistance and impact resistance. Exemplary embodiments can also include acid etched or flared surfaces to increase the impact resistance and increasing the strength of such surfaces by reducing the size and severity of flaws on these surfaces as discussed above. Thus, when an exemplary laminate structure is impacted 10 by an external object such as a stone, hail, foreign road hazard object or by a blunt object used by a potential car thief, the appropriate surfaces 15, 19 of the structure 10 can be placed in a state of tension. To reduce the occurrence of penetration of the impacting object into the vehicle, it is desirable to make these surfaces 15, 19 as strong as possible by a suitable etching mechanism. If etched immediately prior to lamination, the strengthening benefit of etching or flaring can be maintained on surfaces bonded to the inter-layer.

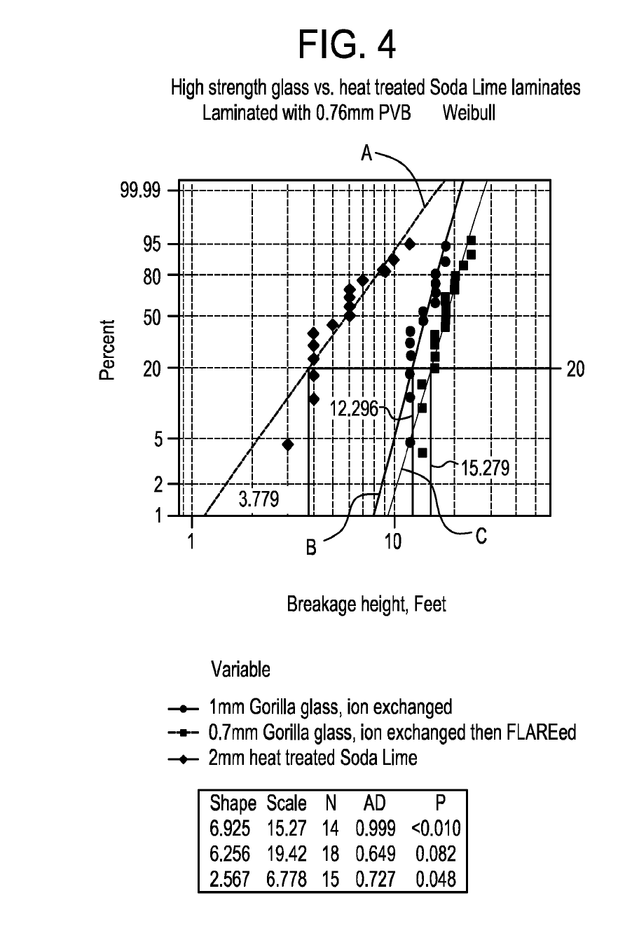

FIG. 4 is a Weibull plot summarizing ball drop height breakage data for three types of laminate structures upon impact on the external surface thereof. With reference to FIG. 4, the tested glass types included type A (a commercially available automotive windshield laminate formed of two sheets of heat treated 2.0 mm thick soda lime glass), type B (a laminate of two sheets of 1 mm thick Corning Gorilla® Glass), and type C (a laminate of two sheets of 0.7 mm thick acid etched Corning Gorilla® Glass). The data was obtained using a standard 0.5 lb. steel ball impact drop test set-up and procedures as specified in ANSIZ26 and ECE R43 with a difference from the standard being that testing was started at a lower height and increased by one foot increments until the respective laminate structure fractured. As illustrated, the data confirms that type A soda lime glass laminate structures have a much lower ball drop breakage height compared to type B Corning Gorilla® Glass laminate structures and type C acid etched Corning Gorilla® Glass laminate structures. As illustrated in FIG. 4, type B Corning Gorilla® Glass laminate structures have a much higher ball drop breakage height impact resistance (a demonstrated 20th percentile of about 12.3 feet) than the type A soda lime glass laminate structures (a demonstrated 20th percentile of about 3.8 feet). With a further treatment of acid etching, type C acid etched Corning Gorilla® Glass laminate structures demonstrated a 20th percentile of about 15.3 feet ball drop breakage height. As illustrated, both Corning Gorilla® Glass laminate structures demonstrated a superior resistance to external impacts.

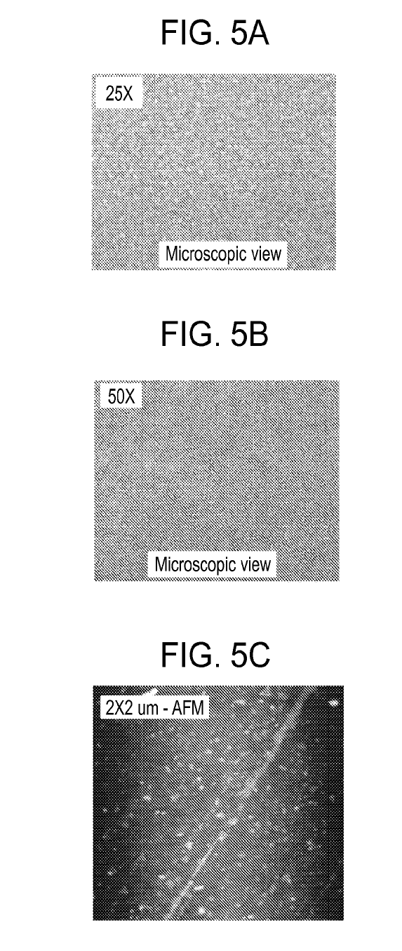

Concerns related to damage levels of impact injuries to a vehicle occupant, however, has required a relatively easier breakage for automotive glazing products. For example, in ECE R43 Revision 2, there is a requirement that, when the laminate is impacted from an internal object (by an occupant's head during a collision), the laminate should fracture so as to dissipate energy during the event and minimize risk of injury to the occupant. This requirement has generally prevented direct use of high strength glass as both plies of a laminate structure. Thus, in other embodiments of the present disclosure, a coated transparent layer can be provided on one or more surfaces of an exemplary laminate structure, either global or localized, for the purpose of creating a controlled and acceptable breakage strength level for the glass layer and/or laminate. For example, in some embodiments, a coated transparent layer can be provided on the surface 17 of the inner layer 16, e.g., the surface adjacent the interlayer 14. Thus, during an internal impact event the acid etched surfaces 15, 19 of the glass structure 10 will be in tension and the presence of a coated transparent layer, e.g., a porous coating on the surface 17 of the inner layer 16 can trigger breakage of the structure and ensure that the structure 10 properly reacts when impacted from the interior, for example during passenger head impact. An exemplary weakening coating can be provided on the surface 17 by use of, for example, a low temperature sol gel process. As typical applications require good optical properties, exemplary coatings may be transparent with a haze reading under 10%, optical transmission at visible wavelengths greater than 20%, 50%, or 80%, and an optionally low birefringence which allows undistorted viewing for users wearing polarized glasses or in certain transparent display structures. FIGS. 5A-5B are microscopic views, 25× and 50×, respectively, of an exemplary coated surface 17 of a thin Gorilla® Glass laminate structure. FIG. 5C is an atomic force microscopy (AFM) view of an exemplary coated surface 17 of a thin Gorilla® Glass laminate structure. With reference to FIGS. 5A-5C, it can be observed that an exemplary sol gel or other suitable porous coating can provide a roughness reading of less than about 3 to 5 nm in rms. As illustrated, the sol gel coating has a 9% haze and includes a relatively rough and porous surface. Exemplary coatings can also have a thickness of from about 0.1 μm to about 50 μm.

Thus, one embodiment of the present disclosure provides a laminate structure having a first glass layer, a second glass layer, and at least one polymer interlayer intermediate the first and second glass layers. The first glass layer can be comprised of a thin, chemically strengthened glass having a surface compressive stress of between about 500 MPa and about 950 MPa and a depth of layer (DOL) of CS greater than about 35 μm. In another embodiment, the second glass layer can also be comprised of a thin, chemically strengthened glass having a surface compressive stress of between about 500 MPa and about 950 MPa and a depth of layer (DOL) of CS greater than about 35 μm. Preferable surface compressive stresses of the first and/or second glass layers can be approximately 700 MPa. In some embodiments, the thicknesses of the first and/or second glass layers can be a thickness not exceeding 1.5 mm, a thickness not exceeding 1.0 mm, a thickness not exceeding 0.7 mm, a thickness not exceeding 0.5 mm, a thickness within a range from about 0.5 mm to about 1.0 mm, a thickness from about 0.5 mm to about 0.7 mm. Of course, the thicknesses and/or compositions of the first and second glass layers can be different from each other. Additionally, the surface of the first glass layer opposite the interlayer can be acid etched, and the surface of the second glass layer adjacent the interlayer can be acid etched. In another embodiment, the surface of the first glass layer in contact with the interlayer can be acid etched, and the surface of the second glass layer opposite the interlayer can be acid etched. In a preferred embodiment, the surface of the first glass layer in contact with the interlayer can be acid etched, the surface of the second glass layer opposite the interlayer can be acid etched, and the surface of the second glass layer adjacent the interlayer may be porous or may comprise a porous coating, weakening coating, sol gel coating, vapor-deposited coating, UV or IR-blocking coating, a coating having a lower strain-to-failure than the second glass layer, a coating having a lower fracture toughness than the polymer interlayer, a coating having an elastic modulus greater than about 20 GPa, a coating being thicker than about 10 nanometers, a coating having intrinsic tensile film stresses, or other suitable transparent coating. Exemplary polymer interlayers include materials such as, but not limited to, poly vinyl butyral (PVB), polycarbonate, acoustic PVB, ethylene vinyl acetate (EVA), thermoplastic polyurethane (TPU), ionomer, a thermoplastic material, and combinations thereof.

With continued reference to FIG. 3, another exemplary laminate structure 10 embodiment is illustrated having an outer layer 12 of glass with a thickness of less than or equal to 1.0 mm and having a residual surface CS level of between about 500 MPa to about 950 MPa with a DOL of greater than 35 microns, a polymeric interlayer 14, and an inner layer of glass 16 also having a thickness of less than or equal to 1.0 mm and having a residual surface CS level of between about 500 MPa to about 950 MPa with a DOL of greater than 35 microns. As illustrated, the laminate structure 10 can be flat or formed to three-dimensional shapes by bending the formed glass into a windshield or other glass structure utilized in vehicles and can include any number of acid etched or weakened surfaces as described above.

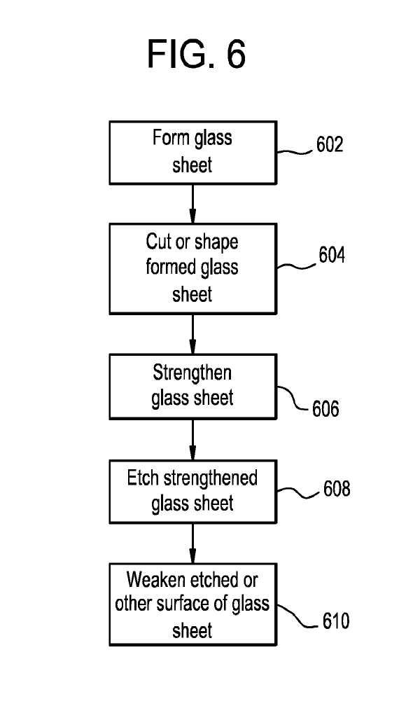

FIG. 6 is a flow diagram illustrating additional embodiments of the present disclosure. With reference to FIG. 6, a method is provided for manufacturing an exemplary laminated glass structure. In step 602, one or more glass sheets can be formed by fusion drawing as discussed above resulting in a glass sheet having a substantially pristine surface. In step 604, the glass sheet can be cut to a predetermined size and/or formed into complex, three-dimensional shapes. In step 606, the formed glass can be strengthened by, for example, a suitable chemical strengthening process (ion exchange) or other strengthening process. In step 608, the chemically strengthened glass can be further strengthened as discussed above by acid etching or flaring, if required. Alternatively, if a surface of the strengthened glass is to be weakened, then in step 610, the surface can be coated with an exemplary transparent coating such as, but not limited to, a porous sol gel coating. This coating step can be a low temperature sol gel process to ensure no unnecessary drop in the level of CS and DOL originally formed in step 606. In some embodiments, an exemplary temperature for the sol gel process can be, but is not limited to, below about 400° C. In an alternative embodiment, an exemplary temperature for the sol gel process can be below or equal to about 350° C. In the described embodiment, the acid etching was described as being performed before the coating of the porous layer or coat; however, the claims appended herewith should not be so limited as the acid etching step can be performed either before or after the low temperature sol gel coating process.

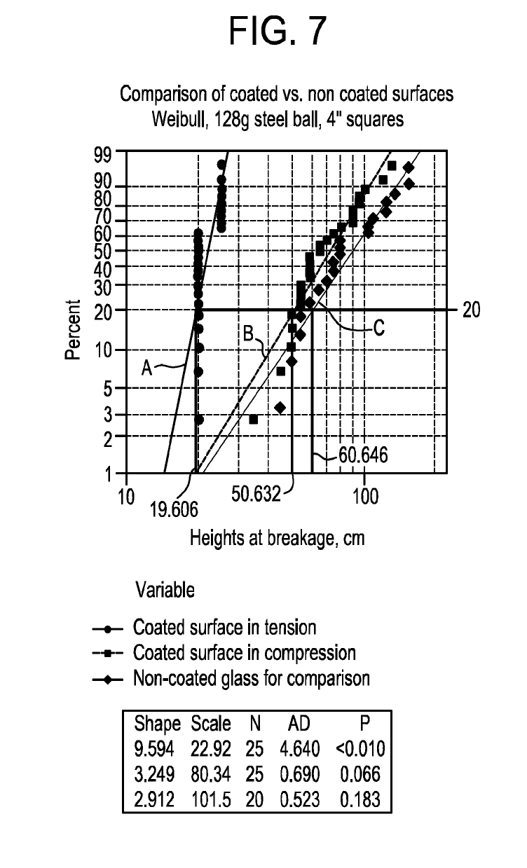

FIG. 7 is a Weibull plot summarizing ball drop height breakage data for three exemplary laminate structures upon impact on the external surface thereof. With reference to FIG. 7, the tested laminate structures included coated surfaces 17 of a glass layer 16 (Corning Gorilla® Glass) in an exemplary laminate structure 10 in tension (type A) in compression (type B) and a non-coated surface (type C) for comparison. The data was obtained using a standard 0.5 lb. steel ball impact drop test set-up and procedures as specified in ANSIZ26 and ECE R43. Type A and Type B samples were made from 1 mm Corning Gorilla® Glass and coated with a low temperature sol gel process (baked at 350° C.). As illustrated in FIG. 7, with the coated surface placed in tension (type A), the 20th percentile Weibull value of breakage heights was about 19 cm, significantly lower than the 20th percentile Weibull values either with the coated surface in compression (type B) or with a non-coated Corning Gorilla® Glass layer (type C). It should be noted, however, that the 20th percentile Weibull value of breakage heights for the coated surface in compression (type B) was similar to the non-coated Corning Gorilla® Glass (type C) meaning that a non-coated surface for an exemplary glass sheet is not significantly affected by the low temperature sol gel process. Based on this data, it can be concluded that some embodiments of the present disclosure provide an exemplary light weight laminate structure having superior resistance from external impacts and also provide a controlled or as-wanted impact behavior from interior impacts to thereby meet head form criteria.

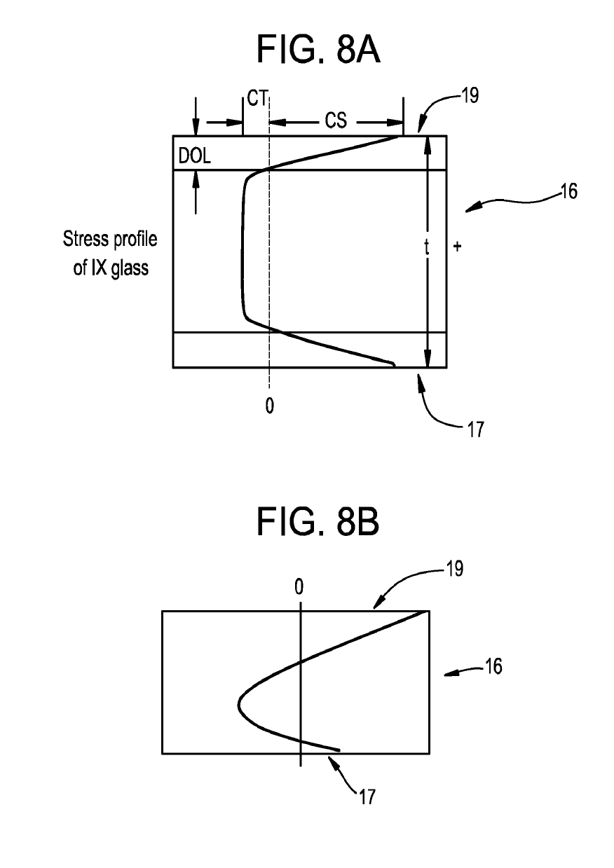

In an alternative embodiment and with continued reference to FIGS. 2 and 3, the inner glass layer 16 can be strengthened glass and can be cold formed to a curved outer glass layer 12. In an exemplary cold forming method, a thin, flat sheet of chemically strengthened glass 16 can be laminated to a relatively thicker, e.g., about 2.0 mm or greater, curved outer glass layer 12. The result of this cold formed lamination is that the surface 17 of the inner layer adjacent the interlayer 14 will have a reduced level of compression thus rendering it easier to fracture when impacted by an internal object. Furthermore, this cold form lamination process can result in a high compressive stress level on the interior surface 19 of the inner glass layer 16 making this surface more resistant to fracture from abrasion and can add further compressive stress on the exterior surface 13 of the outer glass layer 12 also making this surface more resistant to fracture from abrasion. In some non-limiting embodiments, an exemplary cold forming process can occur at or just above the softening temperature of the interlayer material (e.g., about 100° C. to about 120° C.), that is, at a temperature less than the softening temperature of the respective glass sheets. Such a process can occur using a vacuum bag or ring in an autoclave or another suitable apparatus. FIGS. 8A-8B are cross sectional stress profiles of an exemplary inner glass layer according to some embodiments of the present disclosure. It can be observed in FIG. 8A that the stress profile for a chemically strengthened inner glass layer 16 exhibits substantially symmetrical compressive stresses on the surfaces 17, 19 thereof with the interior of the layer 16 in tension. With reference to FIG. 8B, it can be observed that the stress profile for a chemically strengthened inner glass layer 16, according to an exemplary cold formed embodiment, provides a shift in compressive stress, namely, the surface 17 of the inner layer adjacent the interlayer 14 has a reduced compressive stress in comparison to the opposing surface 19 of the inner glass layer 16. This difference in stress can be explained using the following relationship:

σ=Ey/ρ

where E represents the modulus of elasticity of the beam material, y represents the perpendicular distance from the centroidal axis to the point of interest (surface of the glass), and ρ represents the radius of curvature to the centroid of the glass sheet. It follows that the bending of the inner glass layer 16 via cold forming can induce a mechanical tensile stress or a reduced compressive stress on the surface 17 of the inner layer adjacent the interlayer 14 in comparison to the opposing surface 19 of the inner glass layer 16.

Thus, another embodiment of the present disclosure provides a laminate structure having a first glass layer, a second glass layer, and at least one polymer interlayer intermediate the first and second glass layers. The first glass layer can be comprised of a relatively thick annealed or other suitable glass material, e.g., about 2 mm or greater, about 2.5 mm or greater, a thickness ranging from about 1.5 mm to about 7.0 mm, etc. The first glass layer is preferably thermally shaped to a desired amount of curvature. The second glass layer can be comprised of a thin, chemically strengthened glass having a surface compressive stress of between about 500 MPa and about 950 MPa and a depth of layer (DOL) of CS greater than about 35 μm. Preferable surface compressive stresses of the second glass layer can be approximately 700 MPa. The second glass layer can preferably be laminated or cold-formed to the first glass layer to make the second glass layer comply with the shape or curvature of the first glass layer. This cold forming can thus achieve a desired stress distribution in the second glass layer resulting in superior mechanical properties of an exemplary laminate structure. In some embodiments, the thickness of the second glass layer can be a thickness not exceeding 2.5 mm, a thickness not exceeding 1.5 mm, a thickness not exceeding 1.0 mm, a thickness not exceeding 0.7 mm, a thickness not exceeding 0.5 mm, a thickness within a range from about 0.5 mm to about 1.0 mm, a thickness from about 0.5 mm to about 0.7 mm. Exemplary polymer interlayers include materials such as, but not limited to, poly vinyl butyral (PVB), polycarbonate, acoustic PVB, ethylene vinyl acetate (EVA), thermoplastic polyurethane (TPU), ionomer, a thermoplastic material, and combinations thereof.

In one embodiment a laminate structure is provided having a first glass layer, a second glass layer, and at least one polymer interlayer intermediate the first and second glass layers. The first glass layer can be comprised of a strengthened glass having first and second surfaces, the second surface being adjacent the interlayer and chemically polished, and the second glass layer can be comprised of a strengthened glass having third and fourth surfaces, the fourth surface being opposite the interlayer and chemically polished and the third surface being adjacent the interlayer and having a substantially transparent coating formed thereon. The strengthened glass of the first and/or second layers can be chemically strengthened glass or thermally strengthened glass. In some embodiments, some or all surfaces can have a surface compressive stress of between about 500 MPa to about 950 MPa and a depth of layer of compressive stress of between about 30 μm to about 50 μm. In one embodiment, the second and fourth surfaces have a surface compressive stress greater than the first and third surfaces and have a depth of layer of compressive stress less than the first and third surfaces. Exemplary thicknesses of the first and second glass layers can be, but are not limited to, a thickness not exceeding 1.5 mm, a thickness not exceeding 1.0 mm, a thickness not exceeding 0.7 mm, a thickness not exceeding 0.5 mm, a thickness within a range from about 0.5 mm to about 1.0 mm, a thickness from about 0.5 mm to about 0.7 mm. Of course, the thicknesses and/or compositions of the first and second glass layers can be different. Exemplary polymer interlayers can comprise a material such as, but not limited to, poly vinyl butyral (PVB), polycarbonate, acoustic PVB, ethylene vinyl acetate (EVA), thermoplastic polyurethane (TPU), ionomer, a thermoplastic material, and combinations thereof. An exemplary, non-limiting thickness of the interlayer can be approximately 0.8 mm. An exemplary non-limiting substantially transparent coating can be a sol gel coating. In some embodiments, the chemically polished first and third surfaces can be acid etched.

A related method for reducing the compressive stress on one or more surfaces of the glass laminate structure, such as any of the external-facing surfaces 17, 13 involves combining the substantially transparent coating with the glass laminate in such a way that the substantially transparent coating contributes to a reduction in the glass surface compressive stress, on those surfaces where the transparent coating is disposed. For example, the substantially transparent coating can comprise a porous sol-gel coating that is coated or disposed on one or more glass surfaces prior to ion-exchange. The porosity of the coating can be tailored to allow ion-exchange through the coating, but in such a way that the diffusion of ions into the glass is partially inhibited by the porous sol-gel coating. This can be designed to lead to a lower compressive stress and/or lower DOL on the coated surface of the glass after ion-exchange, relative to the non-coated surface of the glass. The ability to tailor the porosity and diffusion properties of the sol-gel coating leads to a wide range of tunability of this behavior. A significant imbalance of the compressive stress between the two sides of the glass will result in some bowing of the glass, which again can be designed to be commensurate with future cold-forming lamination to a 2nd glass sheet, such as through having an ion-exchange-induced bowing that is slightly less than the amount of bowing or bending desired in the final laminate after cold-forming and lamination. In this particular embodiment where the transparent coating is applied before ion-exchanged, the temperature of processing or curing the transparent coating may preferably be higher than in other embodiments, for example as high as 500° C. or 600° C.

Some embodiments of the present disclosure provide a method of providing a laminate structure. The method includes providing a first glass layer and a second glass layer, strengthening one or both of the first and second glass layers and laminating the first and second glass layers using at least one polymer interlayer intermediate the first and second glass layers. The method also includes chemically polishing (acid etching) a second surface of the first glass layer, the second surface being adjacent the interlayer, chemically polishing a fourth surface of the second glass layer, the fourth surface being opposite the interlayer, and forming a substantially transparent coating on the third surface of the second glass layer, the third surface being adjacent the interlayer. In further embodiments, the step of strengthening one or both of the first and second glass layers further comprises chemically strengthening or thermally strengthening both the first and second glass layers. In other embodiments, the step of chemically polishing the second surface further comprises acid etching the second surface to remove not more than about 4 μm of the first glass layer, not more than 2 μm of the first glass layer, or not more than 1 μm of the first glass layer. In additional embodiments, the step of chemically polishing the fourth surface further comprises acid etching the fourth surface to remove not more than about 4 μm of the second glass layer, not more than 2 μm of the second glass layer, or not more than 1 μm of the second glass layer. In an alternative embodiment, the step(s) of chemically polishing a second surface and chemically polishing a fourth surface are performed prior to the step of laminating. In some embodiments, the steps of chemically polishing a second surface and chemically polishing a fourth surface both further comprise etching the respective second and fourth surfaces to provide surface compressive stresses of between about 500 MPa to about 950 MPa and a depths of layer of compressive stress of between about 30 μm to about 50 μm for each respective surface. In a preferred embodiment, the step of forming a substantially transparent coating further comprises coating the third surface using a sol gel process at a temperature of below about 400° C. or below or equal to about 350° C.

Further embodiments of the present disclosure provide a laminate structure having a curved first glass layer, a substantially planar second glass layer, and at least one polymer interlayer intermediate the first and second glass layers. The first glass layer can be comprised of an annealed glass, and the second glass layer can be comprised of a strengthened glass having a first surface adjacent the interlayer and a second surface opposite the interlayer, the second glass layer being cold formed to the curvature of the first glass layer to provide a difference in surface compressive stresses on the first and second surfaces. In some embodiments, the strengthened glass of the second glass layer is chemically strengthened glass or thermally strengthened glass. In other embodiments, the surface compressive stress on the first surface is less than the surface compressive stress on the second surface. Exemplary thicknesses of the second glass layer can be, but is not limited to, a thickness not exceeding 1.5 mm, a thickness not exceeding 1.0 mm, a thickness not exceeding 0.7 mm, a thickness not exceeding 0.5 mm, a thickness within a range from about 0.5 mm to about 1.0 mm, a thickness from about 0.5 mm to about 0.7 mm. Exemplary polymer interlayers can comprise a material such as, but not limited to, poly vinyl butyral (PVB), polycarbonate, acoustic PVB, ethylene vinyl acetate (EVA), thermoplastic polyurethane (TPU), ionomer, a thermoplastic material, and combinations thereof. An exemplary, non-limiting thickness of the interlayer can be approximately 0.8 mm. Exemplary thicknesses of the first glass layer can be, but is not limited to, a thickness of about 2 mm or greater, about 2.5 mm or greater, and a thickness ranging from about 1.5 mm to about 7.0 mm. In some embodiments, the thicknesses of the first and second glass layers can be the same or different.

Additional embodiments provide a method of cold forming a glass structure comprising the steps of providing a curved first glass layer, a substantially planar second glass layer, and at least one polymer interlayer intermediate the first and second glass layers and laminating the first glass layer, second glass layer and polymer interlayer together at a temperature less than the softening temperature of the first and second glass layers. The first glass layer can be comprised of an annealed glass and the second glass layer is comprised of a strengthened glass having a first surface adjacent the interlayer and a second surface opposite the interlayer, and the second glass layer can be provided with a substantially similar curvature to that of the first glass layer as a function of said laminating to provide a difference in surface compressive stresses on the first and second surfaces. In some embodiments, the surface compressive stress on the first surface is less than the surface compressive stress on the second surface. In other embodiments, the thicknesses of the first and second glass layers are different.

Embodiments of the present disclosure can thus provide light weight laminate structures having superior performance in external impact resistance over conventional laminate structures while achieving a desired controlled behavior when impacted from the interior of a vehicle. Some embodiments which create a weakened surface in a glass layer or differences in compressive stress in a glass layer of a laminate structure as described above are cost-effective but also do not induce any significant change in CS and DOL of chemically strengthened glass and can achieve a high consistency in triggering glass breakage when needed.

While this description can include many specifics, these should not be construed as limitations on the scope thereof, but rather as descriptions of features that can be specific to particular embodiments. Certain features that have been heretofore described in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and can even be initially claimed as such, one or more features from a claimed combination can in some cases be excised from the combination, and the claimed combination can be directed to a subcombination or variation of a subcombination.

Similarly, while operations are depicted in the drawings or figures in a particular order, this should not be understood as requiring that such operations be performed in the particular order shown or in sequential order, or that all illustrated operations be performed, to achieve desirable results. In certain circumstances, multitasking and parallel processing can be advantageous.

As shown by the various configurations and embodiments illustrated in FIGS. 1-8, various embodiments for thin glass laminate structures have been described.

While preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof

1. A laminate structure comprising:
a first glass layer;
a second glass layer; and
at least one polymer interlayer intermediate the first and second glass layers,
wherein the first glass layer is comprised of a strengthened glass having first and second surfaces, the second surface being adjacent the interlayer and chemically polished, and
wherein the second glass layer is comprised of a strengthened glass having third and fourth surfaces, the fourth surface being opposite the interlayer and chemically polished and the third surface being adjacent the interlayer and having a substantially transparent coating formed thereon.

2. The laminate structure of claim 1 wherein the strengthened glass of the first layer or second layers is chemically strengthened glass or thermally strengthened glass.

3. (canceled)

4. (canceled)

5. The laminate structure of claim 1 wherein the first and third surfaces have a surface compressive stress of between about 500 MPa to about 950 MPa and a depth of layer of compressive stress of between about 30 μm to about 50 μm.

6. The laminate structure of claim 1 wherein the second surface has a surface compressive stress greater than the first surface and has a depth of layer of compressive stress less than the first surface.

7. The laminate structure of claim 1 wherein the thicknesses of the first and second glass layers are selected from the group consisting of a thickness not exceeding 1.5 mm, a thickness not exceeding 1.0 mm, a thickness not exceeding 0.7 mm, a thickness not exceeding 0.5 mm, a thickness within a range from about 0.5 mm to about 1.0 mm, a thickness from about 0.5 mm to about 0.7 mm.

8. The laminate structure of claim 1 wherein either one of the thicknesses of the first and second glass layers and the composition of the first and second glass layers are different.

9. (canceled)

10. The laminate structure of claim 1 wherein the polymer interlayer comprises a material selected from the group consisting of poly vinyl butyral (PVB), polycarbonate, acoustic PVB, ethylene vinyl acetate (EVA), thermoplastic polyurethane (TPU), ionomer, a thermoplastic material, and combinations thereof.

11. (canceled)

12. The laminate structure of claim 1 wherein the substantially transparent coating is a sol gel coating.

13. The laminate structure of claim 1 wherein the chemically polished second and fourth surfaces are acid etched.

14.-20. (canceled)

21. A laminate structure comprising:
a curved first glass layer;
a substantially planar second glass layer; and
at least one polymer interlayer intermediate the first and second glass layers,
wherein the first glass layer is comprised of an annealed glass, and
wherein the second glass layer is comprised of a strengthened glass having a first surface adjacent the interlayer and a second surface opposite the interlayer, the second glass layer being cold formed to the curvature of the first glass layer to provide a difference in surface compressive stresses on the first and second surfaces.

22. The laminate structure of claim 21 wherein the strengthened glass of the second glass layer is chemically strengthened glass or thermally strengthened glass.

23. The laminate structure of claim 21 wherein the surface compressive stress on the first surface is less than the surface compressive stress on the second surface.

24. The laminate structure of claim 21 wherein the thickness of the second glass layer is selected from the group consisting of a thickness not exceeding 1.5 mm, a thickness not exceeding 1.0 mm, a thickness not exceeding 0.7 mm, a thickness not exceeding 0.5 mm, a thickness within a range from about 0.5 mm to about 1.0 mm, a thickness from about 0.5 mm to about 0.7 mm and wherein the thickness of the first glass layer is selected from the group consisting of a thickness of about 2 mm or greater, about 2.5 mm or greater, and a thickness ranging from about 1.5 mm to about 7.0 mm.

25.-30. (canceled)

31. A method of cold forming a glass structure comprising:
providing a curved first glass layer, a substantially planar second glass layer, and at least one polymer interlayer intermediate the first and second glass layers; and
laminating the first glass layer, second glass layer and polymer interlayer together at a temperature less than the softening temperature of the first and second glass layers,
wherein the first glass layer is comprised of an annealed glass and the second glass layer is comprised of a strengthened glass having a first surface adjacent the interlayer and a second surface opposite the interlayer, and
wherein the second glass layer is provided with a substantially similar curvature to that of the first glass layer as a function of said laminating to provide a difference in surface compressive stresses on the first and second surfaces.

32. The method of claim 31 wherein the surface compressive stress on the first surface is less than the surface compressive stress on the second surface.

33. The method of claim 31 wherein the thicknesses of the first and second glass layers are different.

34. The laminate structure of claim 12, wherein the thickness of the second glass layer is from about 0.5 mm to about 0.7 mm, and wherein the thickness of the first glass layer is from about 1.5 mm to about 7.0 mm.

35. The laminate structure of claim 12, wherein the thicknesses and the compositions of the first and second glass layers are different.

36. The laminate structure of claim 12, wherein only a portion of the second surface, a portion of the fourth surface, or a portion of the second surface and the fourth surface is chemically polished.
